(19) United States
(12) Patent Application Publication
(10) Pub. No.: US 2009/0301078 A1
(43) Pub. Date: Dec. 10, 2009

(54) SYSTEM FOR RECOVERING THE WASTE HEAT GENERATED BY AN AUXILIARY SYSTEM OF A TURBOMACHINE

(75) Inventors: Rahul J. Chillar, Marietta, GA (US); Michael B. Smith, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/136,337

(22) Filed: Jun. 10, 2008

(51) Int. Cl. F02C 6/18

(52) U.S. Cl. 60/597; 60/39.182

(57) ABSTRACT

A system increasing the efficiency of a powerplant by recovering the waste generated by an auxiliary cooling system is provided. The system may include a condensate loop and a heat recovery loop. These loops may integrate the auxiliary cooling systems of a gas turbine with the heat recovery steam generator of the powerplant. The integration may allow a smaller economizer section, which may increase the efficiency of the powerplant.

### BACKGROUND OF THE INVENTION

The present invention relates generally to systems for increasing the efficiency of a powerplant; more specifically, but not by way of limitation, to systems for utilizing the waste heat generated by a powerplant to decrease the work performed by a heat recovery steam generator.

Generally, many components and/or systems of a powerplant require cooling. These components may include for example, but not limiting of, a generator; a lube oil system; a transformer; a turbine inlet cooling system; a compressor intercooling system cooling, and the like. These components and systems reject the heat generated by inefficiencies (windage, bearings, electrical heating, etc.). Generally, these cooling functions directly impact the performance and efficiency of the powerplant.

Commonly, these systems employ an individual skid that may utilize air or water-cooled heat exchangers. For example, but not limiting of. A generator cooling water skid may use a heat exchanger having water as the cooling medium. A lube oil slid may utilize water-cooled heat exchangers. A compressor intercooling skid may utilize water at ambient temperature. A transformer cooling skid may cool the transformer by using air-cooled heat exchangers. These independent cooling skids reject the waste heat, derived from cooling the aforementioned powerplant components and systems.

A combined cycle powerplant utilizes a heat recovery steam generator (HRSG). The powerplant uses the exhaust from a gas turbine to heat water within the HRSG, for creating steam. The steam condenses and flows to a condensor, after use by a steam turbine or other process. The condensed steam, (hereinafter “condensate”, or the like) flows in a condensate loop to a section of the HRSG for reheating. The HRSG typically has an economizer section, which heats the condensate to an intermediate temperature, before flashing to steam. The use of the economizer in an HRSG reduces the overall efficiency of the powerplant. Currently, there are no known systems that integrate the components of a powerplant such that the aforementioned waste heat is used to heat the condensate and reduces economizer use is eliminated or reduced.

For the foregoing reasons, there is a need for a system that recaptures the waste heat discharge by powerplant auxiliary systems. The system should use the waste heat to increase the temperate of the condensate flowing within the HRSG.

### BRIEF DESCRIPTION OF THE INVENTION

In accordance with an embodiment of the present invention, a system for increasing the efficiency of a powerplant, wherein the powerplant comprises at least one gas turbine and a heat recovery steam generator (HRSG), the system comprising: at least one auxiliary system; wherein the at least one auxiliary system is in fluid communication with at least one component of the powerplant; and removes waste heat received from the at least one component of the powerplant; a condenser integrated with the HRSG, wherein the condenser receives condensate from the HRSG and comprises a condensate loop; wherein the condensate loop transfers a portion of the condensate to an inlet portion of the at least one auxiliary system; and a heat recovery loop, wherein the heat recovery loop utilizes the condensate to transfer waste heat from the at least one auxiliary system to the HRSG; wherein the heat recovery loop increases a temperature of the condensate prior to returning to the HRSG; which reduces the work performed by the HRSG and increases the efficiency of the powerplant.

In accordance with another embodiment of the present invention, a system for integrating components of a powerplant to recapture waste heat discharged by at least one auxiliary system in fluid communication with the powerplant, the system comprising: at least one gas turbine; at least one steam turbine; at least one auxiliary system; wherein the at least one auxiliary system discharges waste heat received from at least one component of the powerplant; and is in fluid communication with the at least one component of the powerplant; a condensor integrated with the HRSG, wherein the condenser receives condensate from the HRSG and comprises a condensate loop; wherein the condensate loop transfers a portion of the condensate to an inlet portion of the at least one auxiliary system; and a heat recovery loop, wherein the heat recovery loop utilizes the condensate to transfer waste heat from the at least one auxiliary system to the HRSG; wherein the heat recovery loop increases a temperature of the condensate prior to flowing into the HRSG; which reduces the work performed by the HRSG and increases the efficiency of the powerplant.

### BRIEF DESCRIPTION OF THE DRAWINGS

These and other features, aspects, and advantages of the present invention will become better understood when the following detailed description is read with reference to the accompanying drawings in which like characters represent like elements throughout the drawings.

FIG. 1 is a schematic illustrating independent cooling skids used to reject waste heat in prior art powerplant auxiliary systems.

FIG. 2 is a schematic illustrating a system for using waste heat to heat the condensate within an HRSG, in accordance with an embodiment of the present invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

Certain terminology is used herein for the convenience of the reader only and is not to be taken as a limitation on the scope of the invention. For example, words such as “upper,” “lower,” “left,” “right,” “front”, “rear” “top”, “bottom”, “horizontal,” “vertical,” “upstream,” “downstream,” “fore”, “aft”, and the like; merely describe the configuration shown in the Figures. Indeed, the element or elements of an embodiment of the present invention may be oriented in any direction and the terminology, therefore, should be understood as encompassing such variations unless specified otherwise.

The present invention has the technical effect of increasing the temperature of the condensate flowing of a HRSG by integrating components of the powerplant that discharge waste heat. An embodiment of the present invention takes the form of a system that may recapture the waste heat to heat the condensate. An embodiment of the present invention may be fabricated of any materials that can withstand the operating environment under which the present invention is exposed.

The present invention may be applied to the wide variety of powerplants that have at least one combustion turbine (gas turbine, aero derivative, or the like); at least one heat recovery steam generator (boiler, HRSG, or the like); and at least one condensor. The following are examples, but not limiting of, the types of powerplant configurations of which the present invention applies. An embodiment of present invention may be applied to a powerplant having a gas turbine, a steam turbine, a HRSG, and a condensor. An embodiment of the present invention may be applied to a powerplant having a gas turbine, a HRSG, and a condensor. Here, the powerplant may use the steam created by the HRSG for another process.

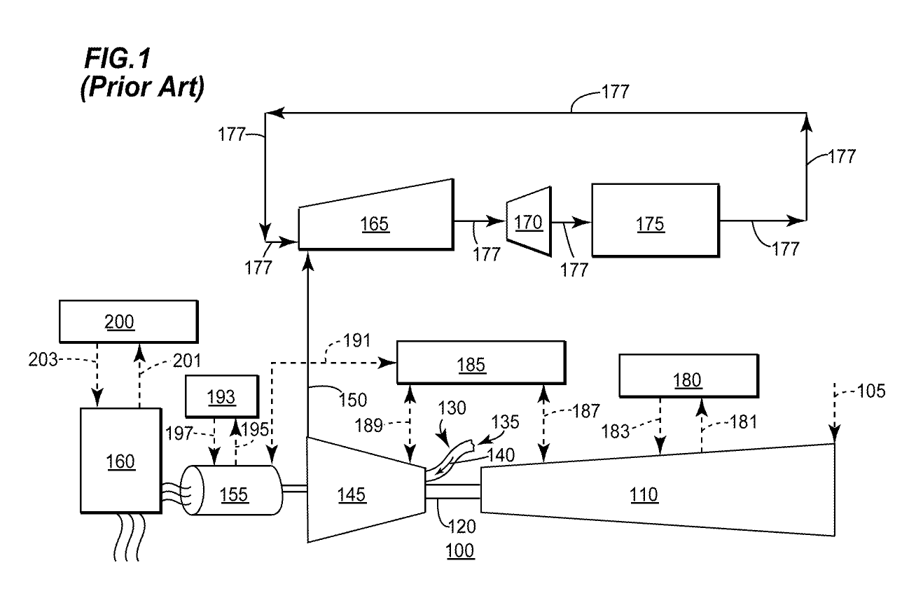

Referring now to the Figures, where the various numbers represent like elements throughout the several views, FIG. 1 is a schematic illustrating independent cooling skids that reject waste heat in a prior art powerplant. FIG. 1 illustrates a powerplant comprising a gas turbine 100; a heat recovery steam generator (HRSG) 165; a steam turbine 170; a condenser 175; and a generator 155.

The gas turbine 100 comprises an axial flow compressor 110 having a rotor shaft 120. Inlet air 105 enters the compressor at 110, is compressed and then discharges to a combustion system 130, where fuel 135, such as a natural gas, is burned to provide high-energy combustion gases 140; that drive the turbine section 145. In the turbine section 145, the energy of the hot gases 140 is converted into work, some of which is used to drive the compressor 110 through the shaft 120, with the remainder available to drive a load such as the generator 155. A transformer 160 is physically coupled to the generator 155; and adjusts the voltage of the electricity produced by the generator 155.

A HRSG 165 may receive the exhaust 150 from the turbine section 145. The heat from the exhaust 150 heats condensate (not illustrated) flowing within the condensate loop 177 of the HRSG 165. The condensate then flashes to steam, which may flow to the steam turbine 170. After generating torque, the steam may flow to the condenser 175, where it condenses returning to condensate form. Boiler feed pumps (not illustrated), or the like, may move the condensate, within the condensate loop 177 to the reenter the HRSG 165, where the aforementioned flow process repeats.

Components of the powerplant, such as, but not limiting of, the gas turbine 100, generator 155, and transformer 160 generate waste heat, which must be removed. These components typically have auxiliary systems, including heat exchangers, or the like, that remove the waste heat. The auxiliary systems may use fluids, such as, but not limiting of, air, oil, and water to cool the fluids used by the auxiliary systems to remove the waste heat. The following are examples, but not limiting of, of fluids commonly used by a specific auxiliary systems. To reduce the temperature of components within the compressor 110, a compressor intercooling slid (CIS) 180 is used, which incorporates water as the cooling fluid. The CIS 180 has a CIS hot line 181, which removes the heated compressed air, which passes through the CIS 180, where cooling occurs; and the CIS cold line 183 returns the cooling air to the compressor 110. To reduce the temperature of the lubrication (lube) oil used within the gas turbine 100 and generator 155, a lube oil-cooling skid (LOCS) 185 is used. The LOCS 185 removes heat from the LOCS 185 by a water-cooled heat exchanger using air at ambient temperature. The LOCS 185 has lines 187,189,191, which circulate the lube oil through the LOCS, allowing for cooler lube oil to return to the gas turbine 100. The generator 155 utilizes a cooling water skid (CWS) 193 to lower the temperatures of internal components. The CWS 193 includes a CWS hot line 195 and a CWS cold line 197 to circulate the cooling fluid through the CWS 193 and generator 155. Components of the transformer 160 are cooled by a transformer cooling skid (TCS) 200. The TCS 200 may utilize oil as a cooling medium. The TCS 200 may utilize a TCS hot line 201 and a TCS cold line 203, to remove the waste heat, similar to the aforementioned processes.

These auxiliary systems, CIS 180, LOCS 185, CWS 193, and TCS 200, are generally not integrated to heat the condensate within the condensate loop 177. The waste heat removed by these systems is not recaptured and thus the heat energy wasted.

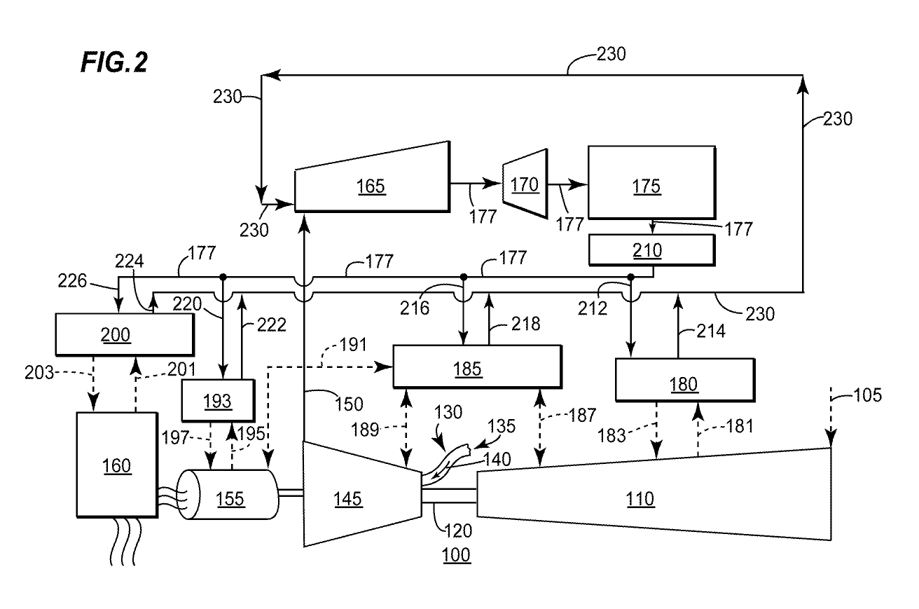

FIG. 2 is a schematic illustrating a system for using waste heat to heat the condensate within an HRSG 165, in accordance with an embodiment of the present invention. As discussed, the present invention may be applied to the wide variety of powerplants that have at least one combustion turbine (gas turbine, aero derivative, or the like) at least one heat recovery steam generator (boiler, HRSG, or the like), and at least one condensor. An embodiment of the present invention is applied to the powerplant configuration illustrated in FIG. 1. The discussion of FIG. 2 will be limited to the present invention.

The present invention utilizes the condensate exiting the condenser 175 as the source of cooling fluid used by the heat exchangers of the auxiliary systems. This feature eliminates the need of supplying various cooling fluids (oil, water, air, or the like) to the heat exchangers. The present invention also transfers the discharge of the heat exchangers (the cooling fluid which is heated) to an inlet portion of the HRSG 165. This feature significantly reduces the work required by the HRSG 165 to increase the temperature of the condensate to allow for steam generation

An embodiment of the present invention recaptures the waste heat discharges by at least one auxiliary system. An embodiment of the present invention integrates the auxiliary system with the flow path of the condensate used with the HRSG 165. As illustrated in FIG. 2, an embodiment of the present invention may include a heat recovery loop 230 in fluid communication with the condensate loop 177.

In an embodiment of the present invention, the condensate loop 177 may begin at an outlet of the condenser 175. The condensate may flow from the condenser 175 to an de-aerator 210, which may remove the majority of air within the condensate. Next, the may flow to a “header” section, or the like, of the condensate loop 177. The header section generally allows for individual connections between the condensate loop 177 and a heat exchanger of an auxiliary system. As illustrated in FIG. 2, each of the aforementioned auxiliary systems, CIS 180, LOCS 185, CWS 193, and TCS 200 may be integrated with the header of the condensate loop 177. This feature allows for the condensate to serve as the cooling fluid supply to each auxiliary system, as discussed. Accordingly, in an embodiment of the present invention: the CIS 180 includes a CIS condensate supply 212; the LOCS 185 includes a LOCS condensate supply 216; the CWS 193 includes a CWS condensate supply 220; and the TCS 200 includes a TCS condensate supply 224.

FIG. 2 also illustrates the flow path of the HRL 230. The HRL 230 serves to transfer the condensate, heated by the waste heat in the plurality of auxiliary system, to the HRSG 165. The HRL 230 may include a header section that allows for individual connectivity with each auxiliary system, similar to the header section of the condensate loop 177. As illustrated in FIG. 2, each of the aforementioned auxiliary systems, CIS 180, LOCS 185, CWS 193, and TCS 200 may be integrated with the header of the HRL 230. Accordingly, in an embodiment of the present invention: the CIS 180 includes a CIS condensate return 214: the LOCS 185 includes a LOCS condensate return 218; the CWS 193 includes a CWS condensate return 222; and the TCS 200 includes a TCS condensate return 226. The HRL 230 flow path may generally start at the header portion and end at the HRSG 165.

As discussed, the present invention reduces the work performed by an economizer section of an HRSG 165. For example, but not limiting of, currently known economizer sections heat the water that returns from the condenser 175, as illustrated in FIG. 1. This “sensible heating” performed by the economizer section may increase the condensate from around 120 degrees Fahrenheit to around 190 degrees Fahrenheit; after which, the condensate may flash to steam. Here, the economizer section heated the condensate roughly 70 degrees Fahrenheit.

The present invention allows for the auxiliary system(s) of the powerplant to perform the majority of the sensible heating. Continuing with the previous example, an embodiment of the present invention may heat the condensate to approximately 150 degrees Fahrenheit, requiring the economizer section to heat the condensate to 190. Here, the economizer section only had to heat the condensate roughly 40 degrees Fahrenheit, a significantly difference. This benefit of the present invention allows for a relatively smaller sized economizer section of the HRSG 165 compared a similarly equipped powerplant not incorporating an embodiment of the present invention.

An operator may experience a few benefits when operating the powerplant with a smaller economizer. A small economizer may create less back-pressure. Generally, the lower the back-pressure, the less work the gas turbine 100 performs in pushing the exhaust 150 to the HRSG 165. A reduction in back-pressure allowing for more energy to drive the load (generator, mechanical drive, or the like); which may increase the efficiency of the gas turbine 100.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims.

What is claimed is:

1. A system for increasing the efficiency of a powerplant, wherein the powerplant comprises at least one gas turbine and a heat recovery steam generator (HRSG), the system comprising:
at least one auxiliary system; wherein the at least one auxiliary system is in fluid communication with at least one component of the powerplant; and removes waste heat received from the at least one component of the powerplant;
a condenser integrated with the HRSG, wherein the condensor receives condensate from the HRSG and comprises a condensate loop, wherein the condensate loop transfers a portion of the condensate to an inlet portion of the at least one auxiliary system; and
a heat recovery loop, wherein the heat recovery loop utilizes the condensate to transfer waste heat from the at least one auxiliary system to the HRSG;
wherein the heat recovery loop increases a temperature of the condensate prior to returning to the HRSG; which reduces the work performed by the HRSG and increases the efficiency of the powerplant.

2. The system of claim 1, wherein the condensate loop is configured to allow the condensate to flow from the condenser through at least one aerator and to an inlet portion of the at least one auxiliary system.

3. The system of claim 2, wherein the heat recovery loop is configured to allow the condensate to flow from a discharge portion of the at least one auxiliary system flows to an inlet portion of the HRSG.

4. The system of claim 3, wherein the at least one auxiliary system comprises a compressor intercooling skid (CIS), wherein the CIS is integrated with the at least one gas turbine; and modulates an internal temperature of a compressor component within the at least one gas turbine.

5. The system of claim 4, wherein an inlet portion of the CIS receives condensate at a first temperature from the condensate loop and discharges condensate at a second temperature to the heat recovery loop.

6. The system of claim 3, wherein the at least one auxiliary system comprises a lube oil cooling skid (LOCS), wherein the LOCS is integrated with the at least one gas turbine; and modulates a temperature of lube oil.

7. The system of claim 6, wherein an inlet portion of the LOCS receives condensate at a first temperature from the condensate loop and discharges condensate at a second temperature to the heat recovery loop.

8. The system of claim 3, wherein the at least one auxiliary system comprises a Cooling Water Skid (CWS), wherein the CWS is integrated with the at least one gas turbine; and modulates a temperature of a cool water system of the at least one gas turbine.

9. The system of claim 8, wherein an inlet portion of the CWS receives condensate at a first temperature from the condensate loop and discharges condensate at a second temperature to the heat recovery loop.

10. The system of claim 3, wherein the at least one auxiliary system comprises a Transformer Cooling Skid (TCS); wherein the TCS is integrated with at least one transformer of the powerplant gas turbine; and modulates a temperature of a cooling fluid of the at least one transformer.

11. The system of claim 10, wherein an inlet portion of the TCS receives condensate at a first temperature from the condensate loop and discharges condensate at a second temperature to the heat recovery loop.

12. A system for integrating components of a powerplant to recapture waste heat discharged by at least one auxiliary system in fluid communication with the powerplant, the system comprising:
at least one gas turbine;
at least one steam turbine;
at least one auxiliary system; wherein the at least one auxiliary system discharges waste heat received from at least one component of the powerplant; and is in fluid communication with the at least one component of the powerplant;
a condenser integrated with the HRSG, wherein the condensor receives condensate from the HRSG and comprises a condensate loop; wherein the condensate loop transfers a portion of the condensate to an inlet portion of the at least one auxiliary system; and
a heat recovery loop, wherein the heat recovery loop utilizes the condensate to transfer waste heat from the at least one auxiliary system to the HRSG;
wherein the heat recovery loop increases a temperature of the condensate prior to flowing into the HRSG; which reduces the work performed by the HRSG and increases the efficiency of the powerplant.

13. The system of claim 12, wherein the condensate loop is configured to allow the condensate to flow from the condenser through at least one aerator and to an inlet portion of the at least one auxiliary system.

14. The system of claim 13, wherein the heat recovery loop comprises is configured to allow the condensate to flow from a discharge portion of the at least one auxiliary system flows to an inlet portion of the HRSG.

15. The system of claim 14, wherein the at least one auxiliary system comprises at least one of: a compressor intercooling skid (CIS); a lube oil cooling skid (LOCS); a cooling water skid (CWS); a transformer cooling skid (TCS); or combinations thereof; and modulates a temperature of the at least one component of the powerplant.

16. The system of claim 15, wherein an inlet portion of the at least one auxiliary system receives condensate at a first temperature from the condensate loop and discharges condensate at a second temperature to the heat recovery loop.

17. The system of claim 12, wherein the condenser comprises an economizer section, wherein the economizer section heats the condensate to temperature near a flashing temperature of the condensate.

18. The system of claim 17, wherein the integration of the condensate loop and the heat recovery loop decreases the amount heating performed by the economizer section, allowing for a smaller economizer section.

19. The system of claim 18, wherein the smaller economizer section reduces the back-pressure experienced by the gas turbine, allowing for an increase in the efficiency of the gas turbine.
